(19) United States
(12) Patent Application Publication
(10) Pub. No.: US 2006/0007842 A1
(43) Pub. Date: Jan. 12, 2006

(54) Cleaning disc for cleaning roller in drive

(75) Inventor: Hung-Jui Lin, Taipei (TW)

Correspondence Address: BRUCE H. TROXELL, SUITE 1404, 5205 LEESBURG PIKE, FALLS CHURCH, VA, 22041, US

(73) Assignee: EPO Science & Technology Inc.

(21) Appl. No.: 10/883,854

(22) Filed: Jul. 6, 2004

(51) Int. Cl. G11B 7/24

(52) U.S. Cl. 369/272.1; 369/275.1

(57) ABSTRACT

A cleaning disc fro cleaning a roller in a drive is used to clean the dust attached on the surface of the roller; it comprises a body whose shape and size are same as a disc; one face of the body is combined with an adhesive film; using adhesive film to contact with the surface of the roller to clean the dust attached on the surface of the roller so as to allow the roller rather not to pollute a disc and a slipping phenomenon is rather not yielded when the disc is driven by the roller to enter or retreat from the drive.

### BACKGROUND OF THE INVENTION

1. Field of the Invention

The present invention relates to a cleaning article for cleaning a roller driving a disc in or out a slot-in drive, and more particularly to a cleaning disc with a shape and size same as a disc and used to clean the surface of the roller when it is driven in or out the drive by the roller.

2. Description of Related Art

A drive is a device that uses an optical pickup head to read data recorded in a disc or to write data into a disc. But, if the disc is not carefully stored, it can be attached with dust easily. The disc attached with dust may influence the quality of the data written or read by the optical pickup head. And, the dust on the disc is easily attached on a lens of the optical pickup head; it also influence the quality of the data written or read by the optical pickup head and even scratch the lens.

Taiwan Patent No. 122,899 discloses a cleaning apparatus for cleaning a signal pickup lens in an optical drive, comprising a cleaning apparatus with a shape and a size approximately same as a general disc; a flywheel disc rotatably connected on the body of the cleaning apparatus; a cleaning portion fixed at another face of the flywheel disc. A fabric or unwoven cloth capable of cleaning a lens is disposed on the cleaning portion. A signal pickup lens can be touched and cleaned by the rotating flywheel continuously.

Please refer to FIG. 1. A general slot-in drive 10 has a roller driving a disc 20 to enter or retreat from the drive 10 for an optical pickup head to read data in a disc 20 or write data into a disc. If dust is attached on the disc 20, when the disc 20 is driven by the roller 11 a part of dust will be attached on the surface of the roller 11. The more dust is attached on the disc 20 the more dust will be attached on the roller used to drive it. If the roller attached with dust is used to drive another clean disc 20 the dust will be attached on it and also pollutes the optical pickup head to influence the quality of data written or read between the optical pickup head and the disc and even scratches a lens of the optical pickup head with larger particles of dust. The friction force between the disc and the roller attached with dust is lowered down so that a slipping phenomenon happens when the disc is driven by the roller to affect the motions that the disc is entered and retreated from the drive.

The cleaning apparatus disclosed by the patent mentioned above can only be used to clean the lens of the optical pickup head and cannot be used to clean the roller driving the disc in or out.

### SUMMARY OF THE INVENTION

For cleaning the dust attached on the surface of a roller in a slot-in drive and a slipping phenomenon is rather not yielded when the roller drives a disc in or out the drive, the present invention is brought out.

The main object of the present invention is to provide a cleaning disc for cleaning a roller in a slot-in drive, used to adsorb the dust on the roller.

Another object the present invention is to provide a cleaning disc for cleaning a roller in a slot-in drive, being able to clean the dust attached on the surface of the roller effectively; the structure thereof is simple and the use thereof is convenient.

### BRIEF DESCRIPTION OF THE DRAWINGS

The present invention can be more fully understood by reference to the following description and accompanying drawings, in which:

FIG. 1 is a schematic view, showing a slot-in drive of the prior art;

FIG. 2 is a schematic view, showing a cleaning disc from which part of a separation type film is lifted according to a preferred embodiment of the present invention;

FIG. 3 is a schematic view, showing a cleaning disc from which a whole separation type film is lifted according to a preferred embodiment of the present invention;

FIG. 4 is a schematic view, showing that a roller in a slot-in drive is cleaned by a cleaning disc according a preferred embodiment of the present invention; and

FIG. 5 is a schematic view, showing a cleaning disc of another preferred embodiment according to the present invention.

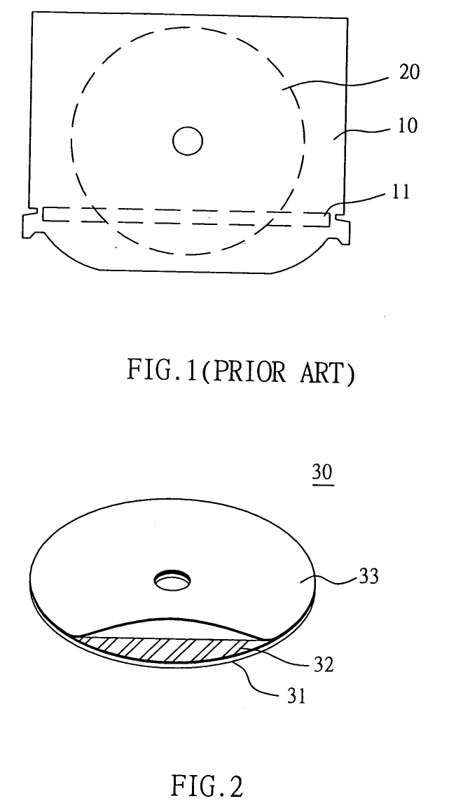

### DETAILED DESCRIPTION OF THE PREFERRED EMBODIMENTS

Please refer to FIG. 2. A cleaning disc 30 comprises a body 31 having a shape and size same as a disc, an adhesive film 32 combined to one face of the body 31. The adhesive film 32 is further combined with a separation film 33 to cause the adhesive film 32 to be sandwiched between the separation type film 33 and the body 31. The adhesive film 32 and the separation type film 33 can be pressure-sensitive adhesive and separation type paper material used in a general market available twin adhesive tape.

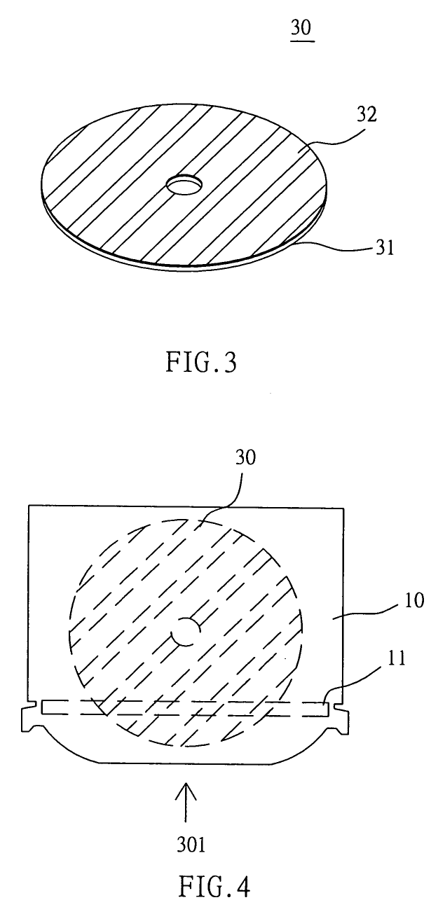

Please refer to FIGS. 3 and 4. When the cleaning disc 30 according to the present invention is used, the separation film is striped from the adhesive film 32 to allow the face combining the adhesive film 32 with the body 31 to be faced to the roller 11 in the drive 10. The cleaning disc 30 is then put inserted into a disc entry 301 to allow the roller 11 to touch and press the adhesive film 32. The body 31 and the adhesive film 32 are driven into the interior of the drive 10 and drive out off the disc entry 301 of the drive 10. Because the roller 11 is touched and pressed the adhesive film 32, the dust attached on the surface of the roller 11 is adsorbed by the stickiness of the adhesive film 32 to cause the surface of the roller 11 to be cleaned.

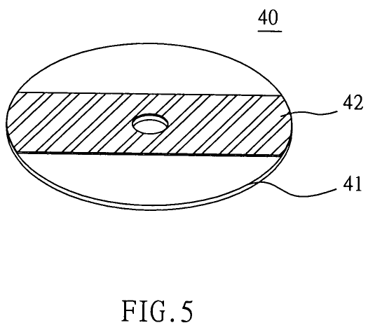

Please refer to FIG. 5. A cleaning disc 40 according to another preferred embodiment of the present invention comprises a body 41 combined with an adhesive film on a part of area thereof and not all area thereof. A roller can also be cleaned by changing the contacting position between the adhesive film 42 and the roller. Naturally, another face of the adhesive film 42 can also be combined with an equal area of separation type film.

The structure of the cleaning disc for cleaning roller according to the present invention is simple, manufacture thereof is easy and use thereof is convenient. The dust attached on the surface of the roller in the drive can be cleaned effectively. Therefore, the disc is not polluted by the roller, the quality of the data written and read between the optical pickup head and the disc can be enhanced, and a slipping phenomenon cannot be yielded to increase the stability when the disc is driven by the roller to enter or retreat from the drive.

It is noted that the cleaning disc for cleaning a roller in a slot-in drive described above is the preferred embodiment of the present invention for the purpose of illustration only, and are not intended as a definition of the limits and scope of the invention disclosed. Any modifications and variations that maybe apparent to person skilled in the art are intended to be included within the scope of the present invention.

What is claimed is:

1. A cleaning disc for cleaning a roller in a drive, used for cleaning the dust attached on the surface of said roller; said cleaning disc comprising a body, said body having a shape and size same as a disc, one face of said body being combined with an adhesive film capable of adsorbing the dust attached on the surface of said roller.

2. The cleaning disc according to claim 1, wherein a part of area of said body is combined with said adhesive film.

3. The cleaning disc according to claim 1, wherein said adhesive film is further combined with a separation type film, said adhesive film is sandwiched between said separation type film and said body.

4. The cleaning disc according to claim 2, wherein said adhesive film is further combined with a separation type film, said adhesive film is sandwiched between said separation type film and said body.
